(19) United States
(12) Patent Application Publication
(10) Pub. No.: US 2022/0219920 A1
(43) Pub. Date: Jul. 14, 2022

(54) POWER SUPPLY MODULE FOR A TRANSPORT SYSTEM, FUNCTION UNIT, SYSTEM, USE, AND ARRANGEMENT

(71) Applicant: OPTIMA consumer GmbH, Schwäbisch Hall (DE)

(72) Inventor: Klaus Hahn, Schrozberg (DE)

(73) Assignee: OPTIMA consumer GmbH, Schwäbisch Hall (DE)

(21) Appl. No.: 17/613,265

(22) PCT Filed: May 19, 2020
(86) PCT No.: PCT/EP2020/063925

§ 371 Date: Nov. 22, 2021

(30) Foreign Application Priority Data
May 23, 2019 (DE) 10 2019 207 587.8

(51) Int. Cl. B65G 54/02; H02J 50/10

(52) U.S. Cl. CPC B65G 54/02; H02J 50/10

(57) ABSTRACT

The invention relates to a power supply module (1) for a transport system (2) which comprises a plurality of carriers (20) which are movable along a transport path (22), comprising a carrier interface (10) with at least one carrier coupling element (100) for mechanical coupling to the carrier (20) of the transport system (2), a function interface (12) with at least one electric connection element (120a, 120b, 120c) for a function device operated by electrical energy, and a receiver (14) of a contactless energy transfer device for receiving energy for the function device, said receiver being connected to the at least one connection element (120a, 120b, 120c). The invention also relates to a function unit comprising a power supply module, to a system for constructing a function unit, the use of a power supply module, and to an arrangement comprising a transport path, a movable carrier, and a function unit.

### FIELD OF APPLICATION AND PRIOR ART

The invention relates to an energy supply module for a transport system, to a functional unit comprising an energy supply module, to a system for setting up a functional unit, to a use of an energy supply module and also to an arrangement having a transport path, a movable carrier and a functional unit.

A transport system refers to a system for transporting objects, for example objects to be packed or filled in the packaging industry. The transport system is for example a belt conveying system, a chain conveying system or a linear motor system and has at least one carrier. In the case of a linear motor system, the carrier is formed as a linear motor rotor, which is mounted movably in relation to a transport path formed as a linear motor path. The carrier can be moved or positioned along the transport path. In some designs, multiple carriers, for example up to 400 carriers, are provided on a transport path. In some designs, the transport path has a spatial extent of up to 30 meters. In combination with additional transporting belts, it is conceivable that the spatial extent of the transport path extends over 100 meters. These spatial extents are however only given by way of example and greater and smaller extents are conceivable.

EP 1 767 474 A2 shows multiple carriers, referred to as self-moving carriers, which have a traction motor of their own or are designed as linear motor rotors, and which have in each case a functional device designed as a gripper. With the gripper, products are gripped and sorted. The self-moving carriers are supplied with energy and data by way of a contactless energy transmission and modulated signals.

### Problem and Solution

The invention addresses the problem of providing a flexibly usable energy supply for a transport system with multiple carriers that can be moved along a transport path, a functional unit for a transport system, an associated system and also a use and an associated arrangement.

This problem is solved by the energy supply module with the features of claim 1, by the functional unit with the features of claim 5, by the system with the features of claim 8 and also by the use with the features of claim 9 and by the arrangement with the features of claim 10. Advantageous designs are described in the subclaims.

According to a first aspect of the invention, an energy supply module for a transport system with multiple carriers that can be moved along a transport path is provided, the energy supply module having a carrier interface with at least one carrier coupling element for mechanical coupling to a carrier of the transport system, a function interface with at least one electrical connection element for a functional device operated by electrical energy and a receiver, electrically connected to the at least one connection element, of a contactless energy transmission device for receiving energy for the functional device.

An energy transmission device comprises at least one stationarily or movably arranged energy transmitting device and at least one receiver, which can be arranged spatially separate therefrom and is provided on the energy supply module.

A functional device operated by electrical energy refers in connection with the application to a device which serves for carrying out a function on an object transported on the carrier and/or on an object provided along the line and to which electrical energy is supplied for this purpose. The function can in this case be chosen appropriately for an application with respect to working steps to be performed along the transport path.

In one design of the invention, it is provided that the functional device is a gripping or clamping system, in particular selected from the group comprising a vacuum gripping system and a mechanical jaw gripping system, and/or a turning system. In connection with the application, a vacuum gripping system refers to a system which has at least one vacuum pump that is supplied with electrical energy by the energy supply module. By means of the vacuum gripping system, objects to be gripped can be gripped. A mechanical jaw gripping system refers to a system which has movable gripping jaws by which objects to be gripped can also be securely gripped, the gripping jaws being individually activatable by supplying electrical energy. A turning system refers to a system by means of which an object can be turned or rotated when energy is supplied. Such a turning system serves in one design for the rotation of an element provided along the transport path. In other designs, the turning system is provided in combination with the gripping or clamping system, for example with the vacuum gripping system or the mechanical gripping system, in order to turn the objects to be gripped and position them appropriately for an application. The turning system comprises in one design an electrically drivable servomotor. Specific applications in which a use of carriers provided with functional devices serves a purpose are evident to a person skilled in the art, without exercising inventive skill, and so such a person also provides further suitable designs of a functional device for the respective specific application and/or combines them with new functional devices or the functional devices mentioned, without exercising inventive skill.

The energy supply module serves for supplying energy to a functional device that can be provided on the carrier of the transport system. The energy supply module comprises for this purpose a receiver, by means of which energy can be received from an external energy source, it being possible for this energy to be made available to the functional device at the at least one connection element.

The energy supply module is a separate unit which can be mechanically connected to the carrier and provides energy for different functional devices by way of connection elements.

The receiver interacts with an external energy transmitting device belonging to the energy transmission device. A person skilled in the art is familiar in this respect with both methods of contactless energy transmission in the near field and in the far field. In some designs, an inductive energy transmission in the near field is provided because of its high efficiency.

In some designs, the external energy transmitting device comprises an energy conductor running at least in some sections along the transport path. The energy conductor in one design runs along the entire transport path. In other designs, interactions are provided in some sections, for example in the region of curves or the like. The receiver performs a function of an antenna for receiving energy and in some designs surrounds the energy conductor, at least in some sections. In one design, the receiver is formed as a U-shaped collector.

The receiver is electrically connected directly or indirectly to the at least one connection element, and so energy for the functional device can be provided at the at least one connection element. The electrical connection comprises in advantageous designs electronic components by means of which the energy transferred to the energy supply module by means of the receiver is converted in a suitable form, buffer-stored or prepared in some other way for the functional device.

The at least one connection element can be suitably designed by a person skilled in the art according to the requirements of the functional devices. In one design, a DC voltage signal is provided at the connection element, a housing part of the energy supply module or of the carrier serving as an associated ground. Preferably, however, at least two connection elements for providing a DC voltage signal, for example of about 24 V, and a ground are provided. In addition to actuating elements, such as motors, pumps or the like, which require comparatively high power, usually provided on the functional device are controlling electronics, which require comparatively lower power. In one design, the energy supply module has for this purpose three connection elements in the form of exposed contacts. A first contact is designed as a ground connection for providing a reference potential. A second contact is designed as an energy load connection for supplying energy to the high-power actuating elements and a third contact is designed as an electronics load connection for supplying to electronic components and/or electronic circuits, in particular controlling electronics. The fact that an energy load connection and a separate electronics load connection are provided means that it is possible according to the situation to make an energy supply available only by way of one of these connection elements for the functional device, while interrupting an energy supply by way of the second connection element.

The carrier coupling elements serve for the mechanical coupling of the energy supply module to the carrier of the transport system and can be suitably designed by a person skilled in the art according to the design of the carrier. In one design, the energy supply module can be coupled to a carrier of a transport system designed as a linear motor system. Such a linear motor system comprises multiple carriers which are designed as a linear motor rotor or coupled to a linear motor rotor. The linear motor rotors can be moved along the transport path designed as a linear motor path. In further designs, the energy supply module can be used with other transport systems, for example with transport systems which allow continuous and discontinuous transportation of objects on carriers, such as belt conveying installations, roller or chain conveyors.

In some designs, mechanical coupling is realized by means of coupling elements based on principles of a form fit and/or a force fit, which allow fastening which can be released nondestructively without tools. Among these coupling elements are for example clamping means and latching means, means which mesh or lock in one another and/or means which form a tongue and groove connection. This makes it possible for a carrier to be quickly converted and/or an energy supply module to be easily exchanged when there is a defect. Alternatively, screw connections or the like and/or magnetic connections are provided.

In one design, the functional device is mechanically coupled to the carrier and is consequently mechanically coupled to the energy supply module only indirectly by way of the carrier.

In a development of the invention, it is provided that the function interface also has at least one function coupling element for mechanical coupling of the energy supply module to the functional device. This allows a secure mechanical connection of the modules to one another, by which a secure electrical connection for reliable energy transmission is also ensured.

In one design, the functional device comprises a communication device for communication with an external control device. In a development of the invention, it is provided that, by means of the contactless energy transmission device, data for and from the energy supply module can be transmitted from and to an external data transmission device. In one design, for this purpose the receiver is designed in such a way that, in addition to receiving energy, data transmission is also possible by means of the receiver. A data exchange for example during an energy transmission to the energy supply module takes place continuously contactless between the receiver and the external data transmission device is interrupted. For example, a data exchange is realized by way of a modulated energy carrier signal. In other designs, the external data transmission device comprises a data conductor running at least in some sections along the transport path. In some designs, the data conductor is arranged parallel to the energy conductor and is in data contact with the receiver, a data exchange being realized for example by way of inductive coupling in of a bus signal. In further designs, the data exchange between the energy supply module and the external data transmission device is realized by means of a communication device, provided on the energy supply module, in such a way that the external data transmission device is in radio range of the receiver and the data exchange consequently takes place by way of a radio transmission. Independently how the data transmission device is designed in relation to the energy supply module, in one design it is provided that the data of the functional device are made available with the energy carrier signal at the at least one connection element. In other designs, further connection elements are provided, data and supply energy being provided at different connection elements.

The data to be transmitted can be suitably chosen by a person skilled in the art according to the application. Data are for example operating data, in order to operate the functional device for a specific application or in a specific way, and/or process data, in order to enquire parameters of the functional device in the case of the specific application and/or transmit them to it for an application. The data can preferably be chosen dependent on the design of the functional device. In some designs, the functional device comprises a gripping system; operating data and/or process data in this case comprise for example gripping-jaw position values and gripping force values of a mechanical gripping system, negative pressure values of a vacuum gripping system. Alternatively or in addition, in some designs the functional device comprises a so-called turning system for turning an object provided on the carrier or along the line; operating data and/or process data in this case comprise for example turning position values of the turning system.

In a development of the invention it is provided that at least one energy and/or data store for storing energy and/or data from the and for the functional device is provided on the energy supply module.

In some designs, only an energy store is provided, serving for supplying to the electronic components and electronic circuits of the functional device and/or the energy supply module. The energy store makes available for example an amount of energy of 30 Watt seconds for the case where the supply of energy by way of the receiver happens to be interrupted or fluctuations in the supply of energy occur. A person skilled in the art is familiar with data and energy stores that are suitable for storing data from and for the functional device and also energy for the functional device. In some designs, the energy supply module has an energy store designed as a storage battery. In one design, charging of the storage battery takes place continuously as long as an energy transmission to the energy supply module takes place. In other designs, charging additionally or only takes place while the energy supply module is in a charging range. In the charging range, the receiver and the external energy transmission device are at a minimum distance from one another. A person skilled in the art is familiar with minimum distances with respect to different methods of contactless data and/or energy transmission, and so can choose these specifically for an application.

According to a second aspect of the invention, a functional unit is provided for connecting to a carrier of a transport system, the functional unit being made up of modules, comprising at least one functional module with a functional device and a previously described energy supply module, the functional module being electrically connected to the energy supply module for supplying energy to the functional module by means of the at least one connection element of the function interface and a complementary connection element of the functional module.

The functional unit is of a modular construction, a modular construction in connection with the application referring to a module-like construction made up of separate elements that are coordinated with one another. In the modular construction, individual modules are formed in such a way that they can be exchanged specifically for an application and/or when there is a defect, without this exchange requiring an exchange of a further module.

In one design, the energy supply module and the functional module are only mechanically coupled to one another indirectly by means of the carrier, not directly. In other designs, the energy supply module and the functional module of a functional unit are mechanically connected to one another by means of function coupling elements, it being possible for the functional unit to be mechanically connected to the carrier by way of the energy supply module. The carrier dictates the carrier interface and the energy supply module can be mechanically connected to the carrier in such a way that it can be released nondestructively by way of the carrier coupling element. In some designs, the carrier coupling element of the energy supply module and the function coupling element of the functional module are of the same design, and so, for an alternative application, the functional module can be directly connected to the carrier without an energy supply. In another design, the carrier coupling element and the function coupling element of the energy supply module are not of the same mechanical design. As a result, the energy supply module can only be mechanically connected to the functional module by way of the function coupling element, while the energy supply module can only be mechanically connected to the carrier by way of the carrier coupling element.

In further designs, multiple functional modules are mechanically and electrically connected to an energy supply module, the functional modules also being linked together and able to be at least electrically connected to the energy supply module.

In a further design, the mechanical connection in the form of the coupling elements and the electrical connection in the form of the connection elements are formed together at a function interface, and so, with the mechanical connection of the modules, an electrical connection between the energy supply module and the functional module is realized.

The functional module is designed specifically for an application, the functional module in one design having a gripping or clamping system, in particular selected from the group comprising a vacuum gripping system and a mechanical jaw gripping system, and/or a turning system.

In a development of the invention, it is provided that data can be transmitted between the functional module and the energy supply module by way of the at least one connection element of the function interface.

In some designs, the energy supply module makes a DC voltage, for example at 24 V, for the functional module available at the function interface, in one design a data exchange taking place by means of modulation of the carrier signal of the DC voltage. The connection elements are preferably designed as exposed contacts, in one design—as described above—three connection elements being provided. The functional module has three contacts formed as complementing the contacts of the energy supply module. In one design, the contacts of the functional module are designed as spring-loaded pins.

In a further design, a communication system is provided for the data exchange between the functional module, the energy supply module and/or the energy supply module and the external data transmission device, the communication system being a so-called IO-Link system according to the standard IEC 61131-9. In advantageous designs, the IO-Link system is used both for data communication between the external data transmission device and the receiver of the energy supply module and for data communication between the energy supply module and the functional module.

According to a third aspect of the invention, a system is provided for setting up a functional unit, comprising at least two functional modules with different functional devices and an energy supply module, it being possible for the at least two functional modules to be combined with the energy supply module appropriately for an application and to be at least electrically connected to the energy supply module by way of uniform interfaces in the form of the at least one connection element of the function interface.

In some designs, individual functional modules are in each case mechanically and electrically connected to an energy supply module by way of the uniform interface, the individual functional modules being able to be exchanged appropriately for an application by virtue of the respectively uniform interfaces. The functional devices are respectively designed in such a way that the power demand corresponds to the energy that is provided by the uniformly designed energy supply module. In some designs, the functional modules and the energy supply module have multiple uniform interfaces in the form of coupling elements and/or connection elements, positions of the functional modules on the energy supply module being variable as a result.

According to a fourth aspect of the invention, a use of an energy supply module with a functional device is provided, the energy supply module for supplying energy or for supplying energy and for exchanging data being at least electrically connected to the functional device by way of the at least one connection element of the function interface.

The energy supply module allows a functional device that requires electrical energy to operate to be provided on a carrier, the required energy being provided by an energy source that is not taken along on the carrier. In some designs, the data exchange, and consequently data communication, between the functional device and an external data transmission device is also ensured by means of the energy supply module.

According to a fifth aspect of the invention, an arrangement is provided, having a transport path in the form of a linear motor path, a movable carrier in the form of a linear motor rotor and at least one functional unit mechanically coupled to the carrier, the at least one functional unit being arranged on the carrier and the carrier being arranged on the transport path.

In some designs, the linear motor rotor is connected to the functional unit, it being possible for the functional unit to be connected to the linear motor rotor at a horizontally arranged carrier interface. In alternative designs, a vertical carrier interface of the functional unit is provided for connecting to the linear motor rotor.

In further alternative designs, at least one carrier adapter is provided, matching the linear motor rotor, for connecting the functional unit to the linear motor rotor. The functional unit can be connected to the carrier adapter by way of the energy supply module and/or by way of the functional module. In some designs, the at least one carrier adapter is formed in such a way that it can be connected to linear motor rotors of different manufacturers by means of an interface matching the linear motor rotors of the different manufacturers. In other designs, different carrier adapters are provided, in each case having an interface adapted to a linear motor rotor of a specific manufacturer.

In further designs, the carrier adapter is connected to the horizontal interface of the functional unit and has an additional vertical interface, the functional unit being connected to the linear motor rotor by means of the additional vertical interface of the carrier adapter. In yet other designs, the interface is arranged at an angle to a horizontal plane of movement, the interface being formed directly at the angle of the functional unit or being formed by means of the carrier adapter.

In some designs, multiple functional units are arranged on a linear motor rotor. In one design, the multiple functional units are connected both to the linear motor rotor and to one another. In some designs, a connection between multiple functional units is realized by means of uniform interfaces.

### BRIEF DESCRIPTION OF THE DRAWINGS

Further advantages and aspects of the invention emerge from the claims and from the following description of exemplary embodiments of the invention, which are explained below on the basis of the figures. The same reference signs are used for the same or similar components or elements in the drawings, in which:

FIG. 1 shows a three-dimensional schematic representation of an energy supply module,

FIG. 2 shows a three-dimensional schematic exploded representation of a first embodiment of an arrangement comprising a carrier of a linear motor system and a functional unit mechanically coupled to the carrier and having a vacuum gripper, together with an object received by the functional unit,

FIG. 3 shows a three-dimensional schematic exploded representation of part of a vacuum gripper similar to FIG. 2, together with an external turning system and an object,

FIG. 4 shows a three-dimensional schematic exploded representation of a second embodiment of an arrangement comprising a carrier of a linear motor system and a functional unit mechanically coupled to the carrier and having a jaw gripping system, together with an object received by the functional unit,

FIG. 5 shows a three-dimensional schematic exploded representation of a jaw gripping system similar to FIG. 4 with an external turning system and an object,

FIG. 6 shows a three-dimensional schematic exploded representation of a third embodiment of an arrangement comprising a carrier of a linear motor system and a functional unit mechanically coupled to the carrier and having a turning system, together with an object received by the functional unit,

FIG. 7 shows a three-dimensional schematic representation of the fourth embodiment of the arrangement similar to FIG. 6 with a data conductor and

FIG. 8 shows a three-dimensional schematic exploded representation of a fifth embodiment of an arrangement, comprising a carrier of a linear motor system and a functional unit mechanically coupled to the carrier.

### DETAILED DESCRIPTION OF THE EXEMPLARY EMBODIMENTS

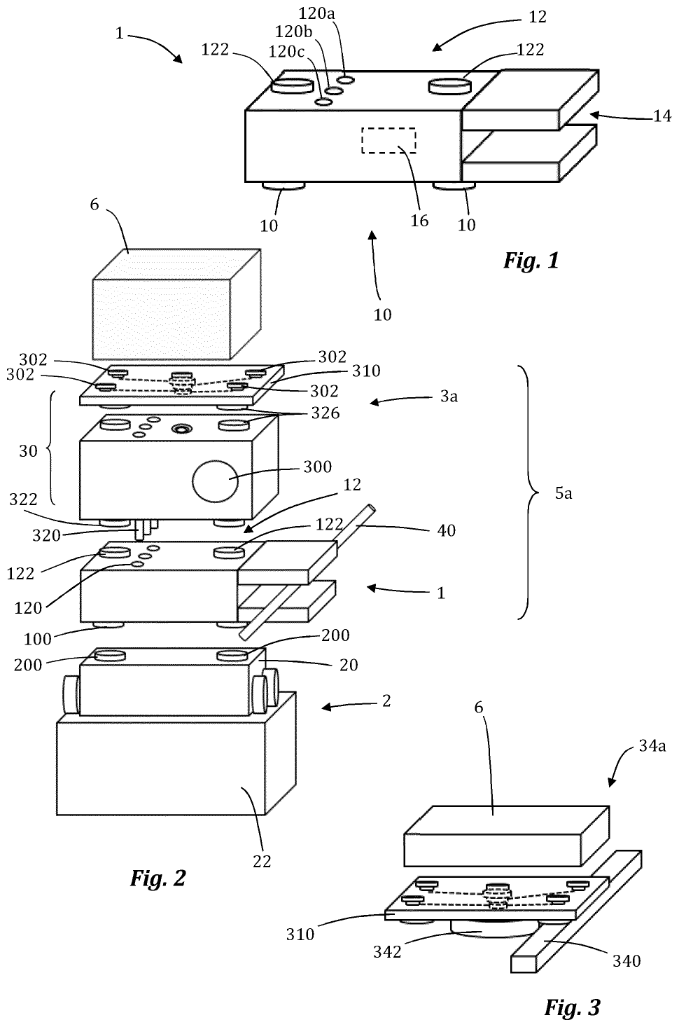

FIG. 1 shows an energy supply module 1 with a carrier interface 10, a function interface 12, a receiver 14 of a contactless energy transmission device and an energy store 16.

The energy supply module 1 serves for supplying energy to a functional device (not shown in FIG. 1), which is provided on a movable carrier (not shown in FIG. 1) of a transport system. The energy supply module 1 comprises for this purpose the receiver 14, by means of which energy can be received from an external energy source. The energy is provided for the functional device at the function interface 12.

The energy supply module 1 can be mechanically connected to a carrier (not shown in FIG. 1) of a transport system by means of the carrier interface 10. For this purpose, the carrier interface 10 shown has on an underside two carrier coupling elements 100. The carrier coupling elements 100 are designed as clamping means with a latching function, and so the energy supply module 1 can be mechanically connected to a carrier (not shown in FIG. 1) of a transport system by means of the carrier coupling elements 100 by way of a form and force fit occurring. The arrangement, number and design of the carrier coupling elements 100 are however only given by way of example and numerous modifications are conceivable.

In the exemplary embodiment shown, the function interface 12 has three connection elements 120a, 120b, 120c in the form of flat, exposed contacts. In the exemplary embodiment, the flat contacts are recessed into a surface of the energy supply module 1.

In addition to the three connection elements 120a, 120b, 120c, the function interface 12 has two function coupling elements 122, which are likewise designed as clamping means with a latching function, and so the energy supply module 1 can be mechanically connected to a further module, for example a functional module 3a, 3b, 3c (not shown in FIG. 1), by means of the function coupling elements 122 by way of a form and force fit occurring. The arrangement, number and design of the function coupling elements 122 are however only given by way of example and numerous modifications are conceivable.

In one design, the energy supply module 1 makes energy available for collectors of varying power at the function interface 12. For this purpose, in the design shown, for example a first connection element 120a is designed as a ground connection, while a second connection element 120b is designed as an energy load connection and a third connection element 120c is designed as an electronics load connection. The numbering of the connection elements 120a, 120b, 120c serves here merely for differentiation and should not be understood as a restrictive definition with respect to the arrangement. The connection elements are also referred to together by the reference sign 120. In one design, a voltage potential of 24 V is respectively provided at the energy load connection and the electronics load connection, the signals provided at the connection elements 120b, 120c differing with regard to their transferable power. For example, power levels of about 20 Watts can be transferred by way of the energy load connection. By contrast, only lower power levels, for example in the range of about 5 Watts, can be transferred by way of the electronics load connection. The energy load connection and the electronics load connection can be used by different collectors, for example by different components of the functional device (not shown in FIG. 1).

In the exemplary embodiment shown, the receiver 14, which is schematically represented in a U-shaped form, is arranged on a side face of the energy supply module 1 that is aligned orthogonally in relation to the carrier interface 10 and the function interface 12. The receiver 14 is electrically connected to the three connection elements 120a, 120b, 120c. In one design, the connection takes place directly. Preferably provided however between the receiver 14 and the connection elements 120a, 120b, 120c are electronic components by means of which the energy received by means of the receiver 14 is converted in a suitable form, buffer-stored or prepared in some other way for the connection elements 120a, 120b, 120c.

In the exemplary embodiment shown, at least the energy store 16 is electrically incorporated between the receiver 14 and the three connection elements 120a, 120b, 120c. The energy store 16 is for example designed in such a way that, if there is no longer a supply of energy to the energy supply module 1, at least an amount of energy of about 30 Watt seconds is available at the electronics load connection for electronics of an attached functional device, whereas an energy supply for higher-power collectors is interrupted.

FIG. 2 shows a first design of an arrangement comprising a carrier 20 and a functional unit 5a mechanically coupled to the carrier 20 and having an energy supply module 1 according to FIG. 1, together with an object 6 received by the functional unit.

The carrier 20 is designed as a linear motor rotor of a linear motor system 2 and can be moved along a linear motor path 22, only one section of a linear motor system 2 being shown in FIG. 2. The energy supply module 1 can be connected to the linear motor rotor of the linear motor system 2 by means of the carrier coupling elements 100. For this purpose, the carrier coupling elements 100 of the energy supply module 1 are designed as matching the linear motor rotor 20. In the exemplary embodiment shown, the carrier 20 has coupling elements 200, the carrier coupling elements 100 and associated coupling elements 200 forming a form- and force-fitting connection, but other types of connection are also conceivable.

The functional unit 5a shown comprises a functional module 3a with a functional device designed as a vacuum gripping system 30.

A vacuum pump 300, which has to be supplied with electrical energy for its operation, is provided on the functional device. The vacuum pump 300 is in flow connection with suction elements 302, and so the object 6 can be sucked into place and held. In the exemplary embodiment shown, the suction elements 302 are provided on a covering 310, which is fluidically coupled to the vacuum pump 300. In one design, the suction elements 302 are assigned activatable valves (not shown), and so the suction elements 302 are individually activatable.

For supplying energy by the energy supply module 1, the functional module 3a shown has three connection elements 320 designed as matching the three connection elements 120 of the energy supply module 1. The connection elements 320 of the functional module 3a are designed as spring-loaded pins, and so, when the functional module 3a is placed onto the energy supply module 1, the connection elements 320 of the functional module 3a are pressed against the connection elements 120 of the energy supply module 1 for the electrical connection to the supply of energy.

In addition to the three connection elements 320, the functional module 3a has two energy-supply module coupling elements 322, which are designed as matching the function coupling elements 122 of the energy supply module 1 and by means of which the functional module 3a can be mechanically connected to the energy supply module 1.

The receiver 14 of the energy supply module 1 receives the energy by an energy conductor 40, which runs along the linear motor path 22 and parallel to it. By means of the energy conductor 40, energy is transferred inductively to the receiver 14 and is provided by the latter for the functional module 3a by way of the connection elements 120a, 120b, 120c. In the schematically represented exemplary embodiment, the energy conductor 40 runs between the legs of the receiver 14, designed in a U-shaped form, of the energy supply module 1, but the representation is only given by way of example.

In the exemplary embodiment shown, the covering 310 and a housing of the vacuum pump 300 are mechanically coupled by means of coupling elements 326. The coupling elements 326 are designed as structurally the same as the coupling elements 122, 322. As a result, it is possible for an alternative design to couple the covering 310 directly to the energy supply module 1.

FIG. 3 schematically shows a covering 310 of the vacuum gripper 30 according to FIG. 2, together with an external turning system 34a and an object 6. The turning system 34a shown is realized by a toothed rack 340 and a toothed wheel 342, the toothed rack 340 being arranged externally, in a way similar to the energy conductor 40, at least in some sections along the linear motor path 22 (cf. FIG. 2) and the toothed wheel 342 being arranged on the functional module 3a. If the functional unit 5a moves in relation to the toothed rack 340 along the linear motor path 22, the toothed wheel 342 engages in the toothed rack 340. There is a turning movement of the covering 310, and consequently a turning of the object 6. In one design it is provided that for this purpose the covering 310 is at least partially mechanically decoupled from a housing of the vacuum pump 300 (cf. FIG. 2), but remains fluidically in connection with the vacuum pump 300. In other designs, a fluidic decoupling also takes place.

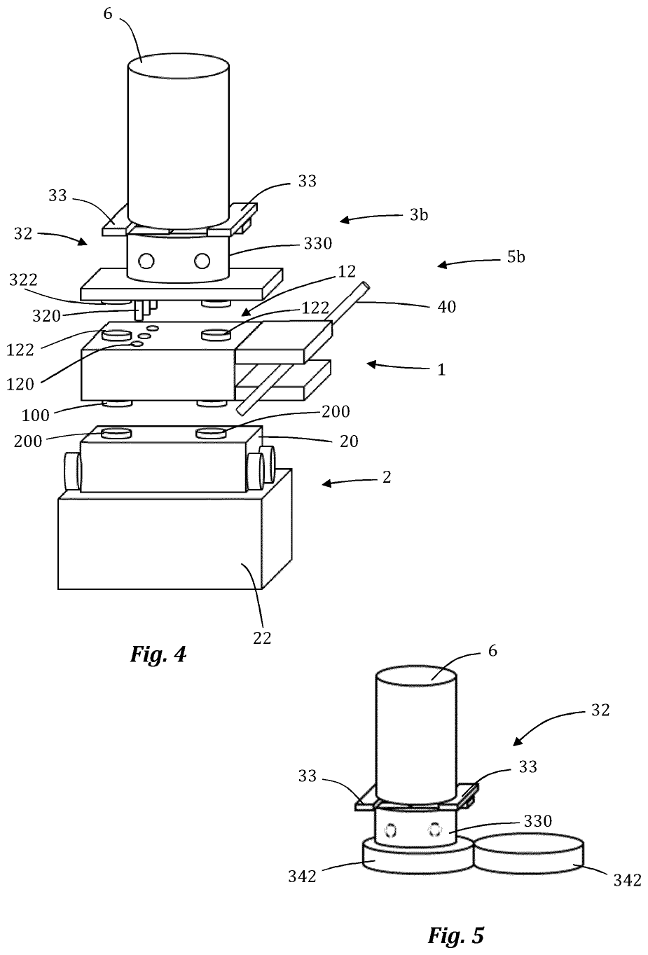

FIG. 4 shows a second design of a functional unit 5b, comprising an energy supply module 1 according to FIG. 1, together with a carrier 20 of a linear motor system 2, receiving this functional unit 5b, and with an object 6 received by the functional unit 5b. The functional unit 5b is similar to the functional unit 5a according to FIG. 2 and the same reference signs are used for the same components.

As a difference from the design according to FIG. 2, in the case of the design according to FIG. 4 a functional module 3b with a jaw gripping system 32 is provided. The functional module 3b has for the jaw gripping system 32 at least one drive, with which gripping jaws 33 can be moved in relation to one another in order to grip the object 6. As in the case of the functional module 3a, the energy for a drive 330 of the functional module 3b is made available by the energy supply module 1, which in turn receives energy contactlessly from the energy conductor 40. The functional module 3b comprises electrical connection elements 320 and energy-supply module coupling elements 322. As the comparison of FIGS. 2 and 4 shows, the electrical connection elements 320 and the energy-supply module coupling elements 322 of the functional modules 3a and 3b are designed as structurally the same, and so the functional modules 3a and 3b can be connected according to choice to the energy supply module 1.

FIG. 5 shows a jaw gripping system 32 similar to FIG. 4 with an external turning system 34b and the object 6 shown by way of example. The turning system 34b shown is realized by two toothed wheels 342, a first toothed wheel 342 being arranged in an externally rotatably driven manner. The first toothed wheel 342 is for example arranged at a position along the linear motor path 22 (cf. FIG. 4). A second toothed wheel 342 is arranged on the functional module 3b. When the functional unit 5b is in the position in which the first toothed wheel 342 engages in the second toothed wheel 342, the first toothed wheel 342 drives the second toothed wheel 342. A turning movement of the gripping jaws 33 occurs, and consequently a turning of the object 6.

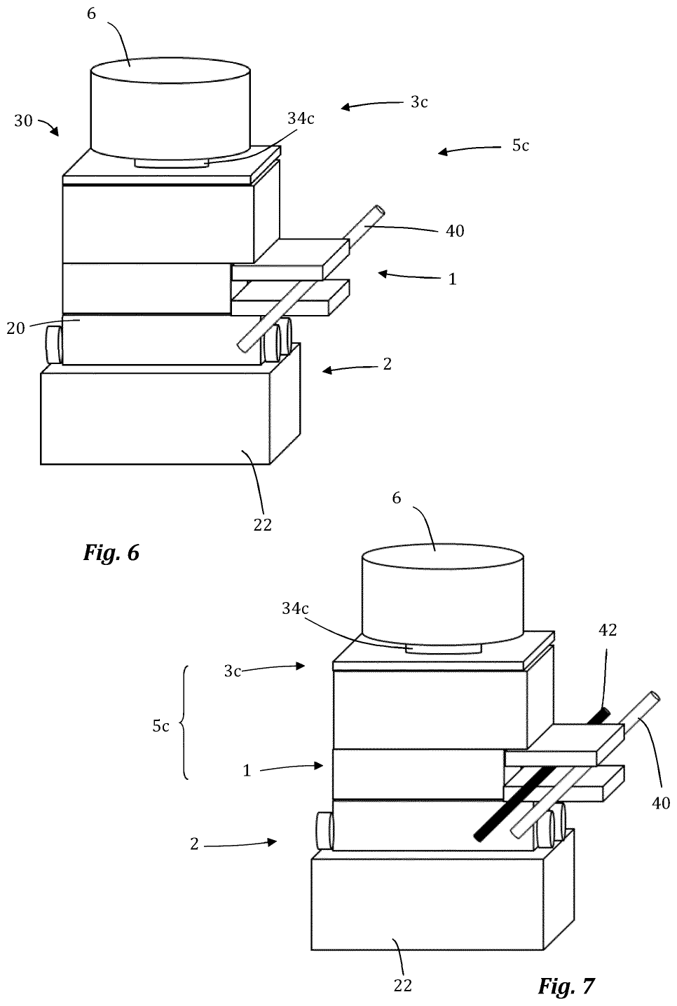

FIG. 6 shows a third design of a functional unit 5c, comprising an energy supply module 1 according to FIG. 1, together with a carrier 20 of a linear motor system 2, receiving this functional unit 5c, and with an object 6 received by the functional unit 5c. The functional unit 5c is similar to the functional unit 5a according to FIG. 2 and the same reference signs are used for the same components.

The functional unit 5c has a functional module 3c, which has a vacuum gripping system 30 and also a turning system 34c. The turning system 34c has an electrically actuated drive, provided on the functional module 3c, and so the object 6 can be turned at any desired position along the linear motor path 22. The functional unit 5c obtains energy for the functional module 3c by way of the energy supply module 1, as described in connection with FIG. 2.

By means of the linear motor system 2, the linear motor rotor 20, and consequently the functional unit 5c, can be moved along the linear motor path 22 and the energy conductor 40 running along the linear motor path 22, and so, depending on the course followed by the energy conductor 40, energy for the functional unit 5c can be provided uninterruptedly or with interruptions along the line.

Preferably, data are also transmitted by an external data transmission device, in particular an external control device (not shown) or the like, to the functional modules 3a, 3b, 3c according to FIGS. 2, 4 and 6.

In one design, a data exchange likewise takes place by means of the connection elements 120, 320, an energy carrier signal being modulated for this purpose. In other designs, additional connection elements are provided for this. In yet other designs, the data exchange between the energy supply module 1 and/or the functional module 3a, 3b, 3c and an external data transmission device (not shown) takes place by radio by means of additional communication devices. Data are operating data and/or process data, such as for example negative pressure values of a vacuum gripping system 30 or turning position values of the turning system 34c and/or actuating signals for the activation or deactivation of the functional devices.

FIG. 7 shows a fourth embodiment of an arrangement similar to FIG. 6. As a difference from FIG. 6, in the case of the design according to FIG. 7 a data conductor 42 is additionally provided, by way of which the data exchange between the energy supply module 1 and/or the functional module 3c and the external data transmission device (not shown) takes place. The data conductor 42 is part of the external data transmission device (not shown) and is connected to it. The data exchange takes place by way of an inductive coupling of a bus signal, and so data are exchanged between the functional module 3c and the external data transmission device by way of the energy supply module 1 and the data conductor 42.

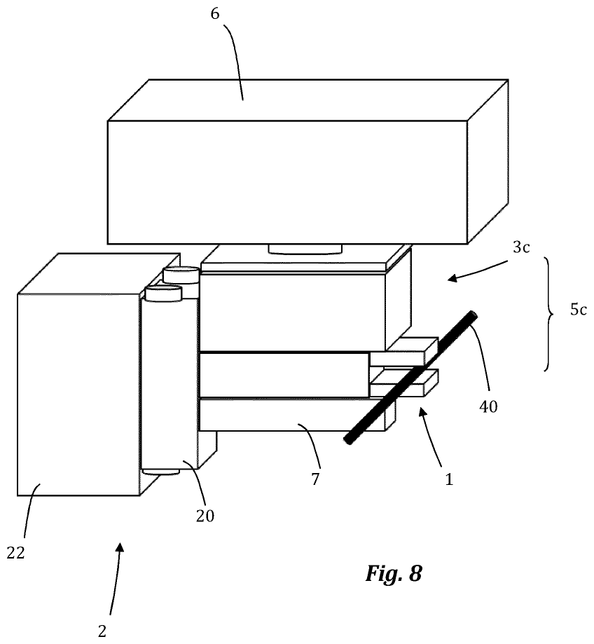

FIG. 8 shows a fifth embodiment of an arrangement comprising a carrier 20 of a linear motor system 2 and a functional unit 5c mechanically coupled to the carrier 20 according to the designs of FIGS. 6 and 7 having an energy supply module 1 according to FIG. 1, together with an object 6 received by the functional unit 5c.

As a difference from the previous embodiments, a linear motor path 22 of the linear motor system 2 according to FIG. 8 does not run in a horizontal plane but extends in a vertical direction. For an attachment of the functional unit 5c to the carrier 20, a carrier adapter 7 is provided. The carrier adapter 7 has a first interface for the energy supply module 1, this being formed as matching the carrier interface 10 of the energy supply module 1 (cf. FIG. 1). The carrier adapter 7 has a second interface for the carrier 20 designed as a linear motor rotor, which is arranged orthogonally in relation to the first interface. Consequently, it is possible by means of the carrier adapter 7 to fasten the functional unit 5c, tilted by 90 degrees, on the carrier 20.

The exemplary embodiments shown are only given by way of example and, as evident to a person skilled in the art, numerous modifications are conceivable.

1. An energy supply module for a transport system with multiple carriers that can be moved along a transport path having:
a carrier interface with at least one carrier coupling element for mechanical coupling to a carrier of the transport system,
a function interface with at least one electrical connection element for a functional device operated by electrical energy, and
a receiver, of a contactless energy transmission device for receiving energy for the functional device, which received is electrically connected to the at least one connection element.

2. The energy supply module as claimed in claim 1, characterized in that the function interface has at least one function coupling element for mechanical coupling to the functional device.

3. The energy supply module as claimed in claim 1, wherein by means of the contactless energy transmission device, data for and from the energy supply module can be transmitted from and to an external data transmission device.

4. The energy supply module as claimed in claim 1, wherein at least one energy and/or data store for storing energy and/or data from the and for the functional device is provided.

5. A functional unit for connecting to a carrier of a transport system, wherein the functional unit is made up of modules,
comprising at least one functional module with a functional device, and
an energy supply module as claimed in claim 1,
the functional module being electrically connected to the energy supply module for supplying energy to the functional module by means of the at least one connection element of the function interface and at least one complementary connection element of the functional module.

6. The functional unit as claimed in claim 5, wherein the functional module has a gripping or clamping system, in particular selected from the group comprising a vacuum gripping system and a mechanical jaw gripping system, and/or a turning system.

7. The functional unit as claimed in claim 5, wherein data can be transmitted between the functional module and the energy supply module by way of the at least one connection element of the function interface.

8. A system for setting up a functional unit as claimed in claim 6, comprising:
at least two functional modules with different functional devices, and
an energy supply module as claimed in claim 1,
it being possible for the at least two functional modules to be combined with the energy supply module appropriately for an application and to be at least electrically connected to the energy supply module by way of uniform interfaces in the form of the at least one connection element of the function interface.

9. The use of an energy supply module as claimed in claim 1 with a carrier comprising a functional device, wherein the energy supply module for supplying energy or for supplying energy and for exchanging data is at least electrically connected to the functional device by way of the at least one connection element of the function interface.

10. An arrangement having:
a transport path in the form of a linear motor path,
a movable carrier in the form of a linear motor rotor and
at least one functional unit as claimed in claim 5 mechanically coupled to the carrier,
the at least one functional unit being arranged on the carrier and the carrier being arranged on the transport path.
